(19) United States
(12) Patent Application Publication
(10) Pub. No.: US 2024/0250309 A1
(43) Pub. Date: Jul. 25, 2024

(54) LAMINATED BATTERY

(71) Applicant: Panasonic Intellectual Property Management Co., Ltd., Osaka (JP)

(72) Inventor: EIICHI KOGA, Hokkaido (JP)

(21) Appl. No.: 18/628,813

(22) Filed: Apr. 8, 2024

Related U.S. Application Data
(63) Continuation of application No. PCT/JP2022/027352, filed on Jul. 12, 2022.

(30) Foreign Application Priority Data
Nov. 8, 2021 (JP) 2021-182151

(51) Int. Cl. H01M 10/0585; H01M 10/0525; H01M 10/658; H01M 50/528; H01M 50/586; H01M 50/59

(52) U.S. Cl. CPC H01M 10/0585; H01M 10/0525; H01M 10/658; H01M 50/528; H01M 50/586; H01M 50/59

(57) ABSTRACT

A laminated battery includes a first unit cell, a second unit cell, and a bonding layer disposed between the first unit cell and the second unit cell. The bonding layer includes a conductor and an insulator. The first unit cell and the second unit cell are electrically connected to each other via the conductor.

### BACKGROUND

### 1. Technical Field

The present disclosure relates to a laminated battery.

### 2. Description of the Related Art

A solid electrolyte layer containing a solid electrolyte having lithium-ion conductivity is disposed between a positive electrode active material layer and a negative electrode active material layer, and the layers are pressed at high pressure, whereby a battery the entirety of which is made of solid materials can be configured.

WO 2012/020699 discloses a laminated solid battery including first and second unit cells and an internal collecting layer disposed so as to be interposed between the first and second unit cells.

### SUMMARY

One non-limiting and exemplary embodiment provides a battery with improved reliability.

In one general aspect, the techniques disclosed here feature a laminated battery including a first unit cell, a second unit cell, and a bonding layer disposed between the first unit cell and the second unit cell, wherein the bonding layer includes a conductor and an insulator, and the first unit cell and the second unit cell are electrically connected to each other via the conductor.

The present disclosure provides a battery with improved reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a sectional view and a plan view of a schematic configuration of a laminated battery of a first embodiment;

FIG. 2 illustrates a sectional view and a plan view of a schematic configuration of a laminated battery of a modification of the first embodiment;

FIG. 3 illustrates a sectional view and a plan view of a schematic configuration of a laminated battery of a second embodiment;

FIG. 4 illustrates a sectional view and a plan view of a schematic configuration of a laminated battery of a third embodiment;

FIG. 5 illustrates a sectional view and a plan view of a schematic configuration of a laminated battery of a fourth embodiment;

FIG. 6 illustrates a sectional view and a plan view of a schematic configuration of a laminated battery of a fifth embodiment;

FIG. 7 illustrates a sectional view and a plan view of a schematic configuration of a laminated battery of a sixth embodiment;

FIG. 8 illustrates a sectional view and a plan view of a schematic configuration of a laminated battery of a seventh embodiment; and

FIG. 9 illustrates a sectional view and a plan view of a schematic configuration of a laminated battery of an eighth embodiment.

### DETAILED DESCRIPTIONS

### Embodiments of the Present Disclosure

The following describes embodiments of the present disclosure specifically with reference to the accompanying drawings.

The embodiments described below all show comprehensive or specific examples. Values, shapes, materials, components, the disposed position and the connection form of the components, and the like shown in the following embodiments are by way of example and have no intended meanings of limiting the present disclosure.

In the present specification, terms indicating the relation between elements, such as parallel, terms indicating the shape of elements, such as rectangular, and value ranges are not expressions only representing strict meanings but are expressions that mean including also substantially the same range, or difference of about a few percent, for example.

The drawings are schematic diagrams and are not necessarily strict drawings. Thus, for example, scales and the like do not necessarily match among the drawings. In the drawings, substantially the same components are denoted by the same symbols, with duplicate descriptions omitted or simplified.

In the present specification and the drawings, an x-axis, a y-axis, and a z-axis show three axes in the three-dimensional Cartesian coordinate system. In the embodiments, the z-axis direction is defined as a thickness direction of a battery. In the present specification, the “thickness direction” refers to a direction perpendicular to the faces of layers laminated on each other.

“In plan view” in the present specification means a case in which a battery is viewed in the laminating direction of the battery, and a “thickness” in the present specification is the length of the battery and each layer in the laminating direction.

In the present specification, unless otherwise noted, in the battery and each layer forming the battery, a “side face” means a face of the battery and each layer extending in the laminating direction, and a “principal face” means a face other than the side face.

In the present specification, as to “in” and “out” in “inside”, “outside”, and the like, when the battery is viewed in the laminating direction of the battery, the central side of the battery is “in”, whereas the peripheral side of the battery is “out”.

In the present specification, the terms “above” and “below” in the configuration of the battery do not indicate the up direction (up in the vertical direction) and the down direction (down in the vertical direction) in the absolute space recognition but are used as terms defined by relative positional relations based on the order of laminating in a laminated configuration. In addition, the terms “above” and “below” are used not only when two components are disposed spaced apart from each other and another component exists between the two components, but also when two components are disposed close to each other, and the two components are in contact with each other.

### First Embodiment

The following describes a laminated battery of a first embodiment.

The laminated battery of the first embodiment includes a first unit cell, a second unit cell, and a bonding layer disposed between the first unit cell and the second unit cell. The bonding layer includes a conductor and an insulator. The first unit cell and the second unit cell are electrically connected to each other via the conductor.

The laminated battery of the first embodiment has the bonding layer including the conductor and the insulator and can thus reduce thermal expansion in the bonding layer and reduce breakage and warping during thermal impact to prevent cracks compared to a case in which, for example, the first unit cell and the second unit cell are connected to each other via the bonding layer including only the conductor. In addition, the laminated battery of the first embodiment can reduce the peeling of the bonding layer and withstand stress by thermal impact by good thermal conductivity of the bonding layer compared to a case in which, for example, the first unit cell and the second unit cell are connected to each other via the bonding layer including only the insulator. Thus, in the laminated battery of the first embodiment, the bonding layer includes the conductor and the insulator, which are portions having different characteristics, and can thus disperse stress applied to the battery in response to temperature changes, for example. Thus, the laminated battery of the first embodiment can efficiently reduce the warping and elongation of the battery caused by pressure bonding and temperature changes by appropriately setting the disposed position, disposed shape, size, material, and the like of each of the conductor and the insulator. In addition, by setting the disposed position, disposed shape, size, material, and the like of each of the conductor and the insulator appropriately in accordance with the state and the area of bonding between the unit cells, the stress applied to the battery can be controlled in a wide range. Thus, the laminated battery of the first embodiment can reduce structural defects (for example, peeling and breakage) at the places in which the unit cells are bonded to each other due to thermal expansion or warping by thermal impact and a cooling and heating cycle. As described above, the laminated battery of the first embodiment has high reliability.

As described in the section of Description of the Related Art, WO 2012/020699 discloses a laminated solid battery including first and second unit cells and an internal collecting layer disposed so as to be interposed between the first and second unit cells. Here, the first and second unit cells each include a positive electrode layer, a solid electrolyte layer, and a negative electrode layer laminated on each other in order. The internal collecting layer is in contact with the positive electrode layer of each of the first and second unit cells or is in contact with the negative electrode layer of each of the first and second unit cells and contains a specific conductive material that is conductive in terms of ion conductivity. However, the internal collecting layer is for connecting the first and second unit cells to each other in parallel and has no insulator. Thus, the laminated solid battery, unlike the present disclosure, cannot reduce the elongation and thermal expansion of the battery.

In the laminated battery of the first embodiment, the first unit cell and the second unit cell may each include a first electrode layer, a solid electrolyte layer, and a second electrode layer in this order. The first electrode layer may include a first collector and a first active material layer, and the second electrode layer may include a second collector and a second active material layer.

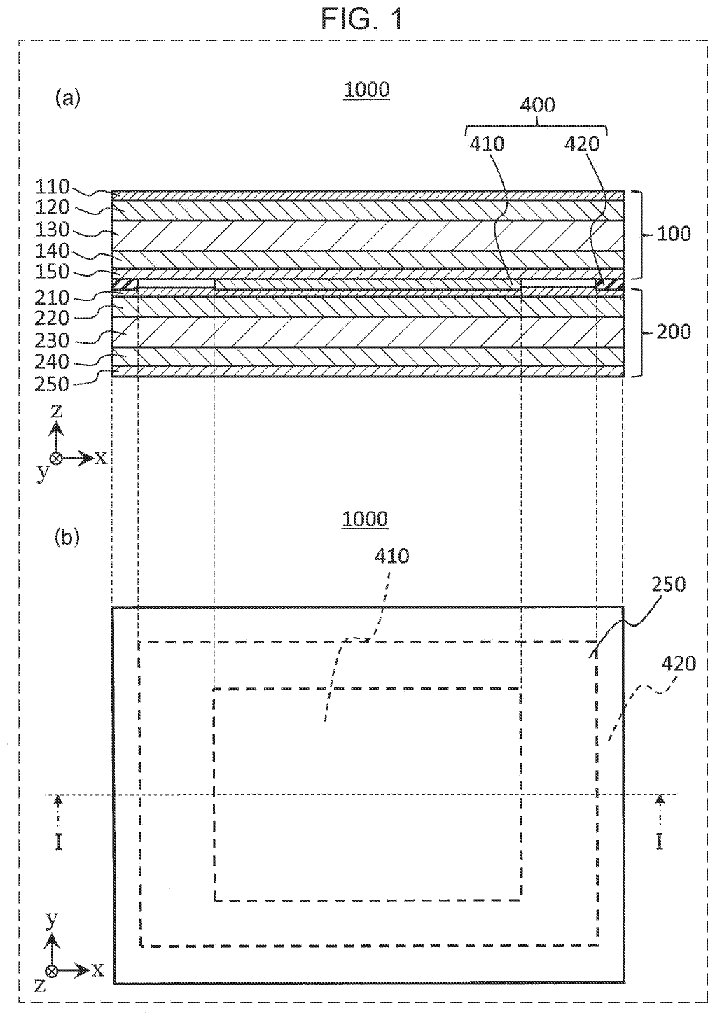

FIG. 1 illustrates a sectional view and a plan view of a schematic configuration of a laminated battery 1000 of the first embodiment.

FIG. 1(a) is the sectional view of the laminated battery 1000 of the first embodiment. FIG. 1(b) is the plan view of the laminated battery 1000 of the first embodiment viewed from below in the z-axis direction. FIG. 1(a) illustrates a section at the position indicated by line I-I in FIG. 1(b).

The laminated battery 1000 includes a first unit cell 100, a second unit cell 200, and a bonding layer 400 disposed between the first unit cell 100 and the second unit cell 200. The bonding layer 400 includes a conductor 410 and an insulator 420.

As illustrated in FIG. 1, the conductor 410 and the insulator 420 may be separate from each other. In this case, the area between the conductor 410 and the insulator 420 may be a cavity. That is, there may be a space surrounded by the conductor 410, the insulator 420, the first unit cell 100, and the second unit cell 200.

The conductor 410 and the insulator 420 may be in contact with each other. When the conductor 410 and the insulator 420 are in contact with each other, they mutually absorb stress and can more reduce the warping and deformation of the battery caused by pressure bonding and temperature changes.

The first unit cell 100 and the second unit cell 200 are electrically connected to each other via the conductor 410.

The above configuration can improve the reliability of the laminated battery 1000.

The first unit cell 100 includes a first collector 110, a first active material layer 120, a solid electrolyte layer 130, a second active material layer 140, and a second collector 150 in this order.

The second unit cell 200 includes a first collector 210, a first active material layer 220, a solid electrolyte layer 230, a second active material layer 240, and a second collector 250 in this order.

The laminated battery 1000 is, for example, an all-solid battery.

The laminated battery 1000 may be a primary battery or a secondary battery.

In FIG. 1, the first unit cell 100 and the second unit cell 200 are laminated on each other so as to be a battery pack connected in series. The first unit cell 100 and the second unit cell 200 each have a thin rectangular parallelepiped structure.

The first unit cell 100 and the second unit cell 200 may be connected to each other in series or connected to each other in parallel.

The first unit cell 100 is bonded to the second unit cell 200 with the bonding layer 400.

All of the first collector 110, the first collector 210, the first active material layer 120, the first active material layer 220, the solid electrolyte layer 130, the solid electrolyte layer 230, the second active material layer 140, the second active material layer 240, the second collector 150, and the second collector 250 may have a rectangular shape in plan view. Examples of the shape other than the rectangular shape include circular, elliptical, and polygonal shapes. The shape is not necessarily the rectangular shape.

In the following, the first collector 110 and the first collector 210 may be collectively referred to simply as a “first collector”. The second collector 150 and the second collector 250 may be collectively referred to simply as a “second collector”. The first collector 110, the first collector 210, the second collector 150, and the second collector 250 may be collectively referred to simply as a “collector”. The first active material layer 120 and the first active material layer 220 may be collectively referred to simply as a “first active material layer”. The second active material layer 140 and the second active material layer 240 may be collectively referred to simply as a “second active material layer”. The first active material layer 120, the first active material layer 220, the second active material layer 140, and the second active material layer 240 may be collectively referred to simply as an “active material layer”. The solid electrolyte layer 130 and the solid electrolyte layer 230 may be collectively referred to simply as a “solid electrolyte layer”. The first unit cell 100 and the second unit cell 200 may be collectively referred to simply as a “unit cell”.

The first collector and the first active material layer may be a positive electrode collector and a positive electrode active material layer, respectively. In this case, the second collector and the second active material layer are a negative electrode collector and a negative electrode active material layer, respectively.

The following describes a specific configuration of the laminated battery 1000.

The material of the collector is not particularly limited so long as it is a material having conductivity.

Examples of the material of the collector include stainless steel, nickel, aluminum, iron, titanium, copper, palladium, gold, platinum, and alloys of two or more of these. As the collector, a foil-like body, a plate-like body, or a mesh-like body formed of these materials can be used.

As the first collector, aluminum (Young's modulus: about 70×10⁹ N/m², thermal expansion coefficient: 24×10⁻⁶/K) may be used, and as the second collector, copper (Young's modulus: about 120×10⁹ N/m², thermal expansion coefficient: 16×10⁻⁶/K) may be used.

The material of the collector can be selected in consideration of a production process, temperature in use, pressure in use, a battery operation potential applied to the collector, or conductivity. The material of the collector can be selected in consideration of tensile strength or heat resistance required for the battery.

The collector may have a thickness of, for example, greater than or equal to 10 μm and less than or equal to 100 μm.

The surface of the collector may be roughened to have irregularities in order to improve bondability or wettability during application. That is, the surface of the collector may have an embossed shape. The surface roughness Rz of the collector may be greater than or equal to 1 μm and less than or equal to 10 μm.

The bonding layer 400 is a layer bonding the first unit cell 100 and the second unit cell 200 to each other. The bonding layer 400 includes the conductor 410 and the insulator 420. The first unit cell 100 and the second unit cell 200 are electrically connected to each other via the conductor 410.

The bonding layer 400 may include only the conductor 410 and the insulator 420.

In the laminated battery 1000, two unit cells are bonded to each other using the bonding layer 400 including the conductor 410 and the insulator 420. Thus, curing stress of layers to be bonded to each other and stress generated by the difference between thermal expansion characteristics of those layers disperse and do not simultaneously concentrate on a bonding interface. For example, the thermal expansion coefficient of the metal for use in the collector is about 20 ppm/K, whereas for the conductor 410, for example, a material with a thermal expansion coefficient of about 7 ppm/K to 15 ppm/K is used, and for the insulator 420, for example, a material with a thermal expansion coefficient of about 3 ppm/K to 5 ppm/K is used. When the difference in the thermal expansion coefficient between the collector and the conductor 410 is large, the insulator 420 may be softer than the collector or softer than the collector and the conductor 410. The Young's modulus of the material for use in the insulator 420 may be smaller than the Young's modulus of the material of the collector or smaller than the Young's modulus of the material of the collector and the Young's modulus of the material of the conductor 410. This enables the insulator 420 to particularly absorb the curing stress of layers to be bonded to each other and the stress generated by the difference between thermal expansion characteristics of those layers. Thus, a laminated battery with the occurrence of peeling and cracks of bonding faces reduced and with warping and deformation reduced can be obtained. These actions improve the durability of the laminated battery against thermal impact and a cooling and heating cycle.

At least one selected from the group consisting of the conductor 410 and the insulator 420 may be in contact with at least one selected from the group consisting of the first unit cell 100 and the second unit cell 200. The conductor 410 and the insulator 420 may be in contact with the first unit cell 100 and the second unit cell 200.

In FIG. 1, both the conductor 410 and the insulator 420 are in direct contact with the surface of the second collector 150 of the first unit cell 100 and the surface of the first collector 210 of the second unit cell 200.

At least part of the bonding layer 400 may have a portion embedded in at least one selected from the group consisting of the first unit cell 100 and the second unit cell 200. At least one selected from the group consisting of the conductor 410 and the insulator 420 may have a portion embedded in at least one selected from the group consisting of the first unit cell 100 and the second unit cell 200.

The conductor 410 and the insulator 420 may have portions embedded in at least one selected from the group consisting of the first unit cell 100 and the second unit cell 200. The conductor 410 and the insulator 420 may have portions embedded in at least one selected from the group consisting of the second collector 150 of the first unit cell 100 and the first collector 210 of the second unit cell 200. This can firmly secure the conductor 410 and the insulator 420 and the unit cell to each other. Consequently, even when impact or thermal impact such as a cooling and heating cycle is applied, the peeling of the unit cell can be reduced. Thus, a battery having high reliability with warping and deformation reduced can be achieved.

The conductor 410 and the insulator 420 may have portions embedded by about 1 μm to 2 μm in the first collector 210 of the second unit cell 200. The conductor 410 and the insulator 420 may have portions embedded by about 10% of the thickness of the collector in the first collector 210 of the second unit cell 200.

As illustrated in FIG. 1(b), the conductor 410 may be disposed at the center of the laminated battery 1000 in plan view.

The conductor 410 has conductivity.

The conductor 410 may contain a conductive resin material. This enables, while achieving electric connection, the deformation (for example, peeling and warping by thermal expansion) of the bonding place of the unit cell to be controlled in a wide range by the elasticity (deformability) of the resin material. Consequently, the durability of the bonding faces against flexural stress and thermal impact can be increased. Thus, the reliability of the battery can be improved.

The conductor 410 may contain a metal. Examples of the metal include Ag, Cu, Ni, and Fe. By using these metals, the conductor 410 can be fixed to the unit cell with high durability by achieving both low resistance electric connection and the deformability of the resin material. Thus, a battery with low resistance loss and having high reliability can be achieved. In addition, the conductor 410 has high conductivity, and thus heat generation by Joule heat is reduced. Thus, the influence of temperature that deteriorates the characteristics of the battery can be reduced.

The conductor 410 may contain silver.

The conductor 410 may contain two or more metals.

Examples of the shape of the metal contained in the conductor 410 include particulate, scale-like, and plate-like shapes.

The conductor 410 may contain a conductive resin and metal particles. As an example, the conductor 410 may contain Ag particles and a thermosetting resin.

The conductor 410 may have a thickness of greater than or equal to 1 μm and less than or equal to 5 μm.

The conductor 410 may be softer than the collector. For example, the conductor 410 may be softer than the second collector 150 of the first unit cell 100 and the first collector 210 of the second unit cell 200.

For the difference in softness, that is, hardness between the conductor 410 and the collector, a relative relation in hardness can be obtained by placing a rigid body intender and comparing sizes of marks as in Vickers hardness. For example, the difference can be obtained by pressing an intender on each part of a section of the battery with the same force and comparing states of dents. The relative relation in hardness can also be estimated from their metal compositions.

The material of the conductor 410 may have a Young's modulus of about 10×10⁹ N/m². The material of the conductor 410 may have a Young's modulus of greater than or equal to 10×10⁹ N/m².

The Ag particles contained in the conductor 410 may be approximately spherical. The Ag particles may have a particle size of greater than or equal to 0.5 μm and less than or equal to 1 μm.

The content of the Ag particles in the conductor 410 may be greater than or equal to 50% by mass and less than or equal to 70% by mass with respect to the other materials forming the conductor 410.

In order for the conductor 410 to have hardness or thermal conductivity adjusted, the content of the metal may be selected. The conductor 410 may contain, for example, metal particles (for example, Ag (Young's modulus: about 80×10⁹ N/m²)) together with a resin material (for example, Young's modulus: about 1×10⁹ N/m² to 3×10⁹ N/m²).

The bonding layer 400 may be an applied film. The conductor 410 may be an applied film.

For example, the conductor 410 may be produced by applying a conductive paste containing metal particles and a thermosetting resin. This enables the conductor 410 in which the metal particles are oriented in plate form to be obtained. This enables stress and thermal expansion in the longitudinal direction and the lateral direction to be widely controlled. As the conductive paste containing metal particles and a thermosetting resin, a thermosetting conductive paste may be used. The thermosetting conductive paste contains highly conductive metal particles with a high melting point (for example, higher than or equal to 400° C.) or metal particles with a low melting point (preferably lower than or equal to the curing temperature of the conductive paste, or lower than or equal to 300° C., for example) and a resin. A conductive paste containing metal particles of silver and a thermosetting resin may be used.

Examples of the material of the highly conductive metal particles with a high melting point include silver, copper, nickel, zinc, aluminum, palladium, gold, platinum, and alloys obtained by combining these metals with each other.

Examples of the material of the metal particles with a low melting point with a melting point of lower than or equal to 300° C. include tin, tin-zinc alloys, tin-silver alloys, tin-copper alloys, tin-aluminum alloys, tin-lead alloys, indium, indium-silver alloys, indium-zinc alloys, indium-tin alloys, bismuth, bismuth-silver alloys, bismuth-nickel alloys, bismuth-tin alloys, bismuth-zinc alloys, and bismuth-lead alloys. By using the conductive paste containing such metal particles with a low melting point, even when a thermosetting temperature is low, which is, for example, lower than or equal to the melting point of the highly conductive metal particles with a high melting point, a solid-phase and liquid-phase reaction proceeds in the contact regions between the metal particles in the conductive paste and the metal forming the collector. An alloy is thereby formed at the interface between the conductive paste and the surface of the collector. Examples of the alloy to be formed include silver-copper-based alloys, which are highly conductive alloys, when silver or a silver alloy is used for the conductive metal particles and copper is used for the collector. Depending on the combination of the conductive metal particles and the collector, silver-nickel alloys, silver-palladium alloys, or the like can also be formed. This configuration enables the unit cells to be bonded to each other more firmly and produces, for example, the effect of reducing the bonding faces from peeling off from each other by a thermal cycle or impact.

Examples of the shape of the highly conductive metal particles with a high melting point and the metal particles with a low melting point include spherical, scale-like, and needle-like shapes.

The particle size of the highly conductive metal particles with a high melting point and the metal particles with a low melting point is not particularly limited. For example, as the particle size becomes smaller, alloy formation proceeds at lower temperatures, and thus the particle size and particle shape are selected as appropriate in consideration of process design and the influence of a thermal history on battery characteristics.

The resin for use in the thermosetting conductive paste is only required to function as a binder for binding, and in addition, appropriate ones may be selected depending on the production process to be employed, such as printability and applicability. The resin for use in the thermosetting conductive paste contains, for example, a thermosetting resin. Examples of the thermosetting resin include:
(i) amino resins such as urea resins, melamine resins, and guanamine resins;
(ii) epoxy resins such as bisphenol A type ones, bisphenol F type ones, phenol novolac type ones, and alicyclic ones;
(iii) oxetane resins;
(iv) phenolic resins such as resol type ones and novolac type ones; and
(v) silicone-modified organic resins such as silicone epoxy and silicone polyester. For the resin, only one of these materials may be used, or two or more of these materials may be used in combination.

The conductor 410 may be a laminated film, not the applied film. The conductor 410 may have a laminated structure in which layers different from each other in the content of the metal particles, the type of the material, or shape are laminated on each other. This enables the reliability of interface bondability or conductivity to be controlled in a wider range.

The conductor 410 may have pores. The hardness of the conductor 410 can be even adjusted by the number of the pores. By increasing the number of the pores, the conductor 410 becomes softer.

The pores can be contained by, for example, stirring the conductive paste for use in the formation of the conductor 410. The pore size is, for example, 0.1 μm to 5 μm. The contained pores can also be removed by decompression processing in lower than or equal to the atmospheric pressure at room temperature. That is, the contained amount of the pores can be adjusted by the pressure or time of the decompression processing.

The pores may be filled with gas. By performing a series of processes from stirring to curing of the paste in an atmosphere of the gas, the pores can be filled with any gas. This enables selection and filling of a gas that does not have a negative effect when being in contact with the collector or the solid electrolyte. Examples of the gas include oxygen, nitrogen, and argon.

The state of the pores such as arrangement, shape, and amount can be evaluated by observing a section of the conductor 410 with an optical microscope, a scanning electron microscope (SEM), or the like.

By observing a polished section with, for example, 500-power to 2,000-power, a pore rate can be calculated from the ratio between the area of the pores and the area of the other.

The insulator 420 is a portion having lower electron conductivity than that of the conductor 410 in the bonding layer 400. The insulator 420, for example, does not substantially have electron conductivity. In the present specification, not substantially having electron conductivity means that the electron conductivity is less than or equal to 10 μS/m, which may be less than or equal to 1 μS/m, for example. The insulator 420 does not necessarily have electron conductivity.

The insulator 420 may contain at least one selected from the group consisting of a resin material having insulating properties (hereinafter, also referred to as an “insulating resin material”) and an oxide. This enables control of the deformation (for example, peeling and warping by thermal expansion) and thermal conductivity of the place in which the unit cells are bonded to each other in a wide range.

The insulating resin material may be an epoxy resin. The epoxy resin may be thermosetting. The thermal conductivity of the epoxy resin may be, for example, less than 1 W/m·K.

The oxide may be alumina (that is, aluminum oxide). Aluminum oxide has a thermal conductivity of 20 W/m·K to 30 W/m·K and a Young's modulus of 300×10⁹ N/m² to 400×10⁹ N/m².

The insulator 420 may have a thickness of greater than or equal to 1 μm and less than or equal to 5 μm.

The insulator 420 may be softer than the conductor 410.

The insulator 420 may be softer than the collector and the conductor 410. For example, the insulator 420 may be softer than the second collector 150 of the first unit cell 100, the first collector 210 of the second unit cell 200, and the conductor 410. This enables the insulator 420 to preferentially absorb the deformation (for example, warping) of the bonding place of the unit cells caused by flexural stress or thermal impact. Consequently, the durability of the electrically connected state of the conductor 410 improves. Thus, the characteristics and the reliability of the battery can be improved.

The material of the insulator 420 may have a Young's modulus of greater than or equal to 1×10⁹ N/m² and less than or equal to 3×10⁹ N/m².

As illustrated in FIG. 1(b), the insulator 420 may be provided in a frame shape along the outer edge of the laminated battery 1000 in plan view. The width of the frame may be about 1,000 μm.

The material of the insulator 420 can be thermosetting. The curing temperature of the material of the insulator 420 may be the same as that of the material of the conductor 410 so that the material of the insulator 420 can be cured simultaneously with the conductor 410 in consideration of productivity. The curing temperature is, for example, 120° C. to 200° C. A large-sized battery has large heat capacity and may thus have different cured states between the outer edge and the center of the battery. Thus, in the large-sized battery, the progress of curing at the center may be delayed compared to that of the outer edge. Thus, the large-sized battery has distribution in which the outer edge of the battery becomes harder in accordance with the distribution of the degree of curing within the battery. By increasing the temperature raising rate of thermosetting or by performing heat treatment in a shorter time, the resin positioned close to the outer edge of the battery can be selectively made hard. The temperature raising rate of thermosetting is, for example, 500° C./hour to 800° C./hour. The time of thermosetting is, for example, 1 minute to 10 minutes. This can increase the impact resistance of the corners and side face of the battery.

To make the distribution of the degree of curing within the battery uniform, resin materials having different curing temperatures may be used for the outer edge and the center. For example, at the center, a material having a relatively low curing temperature may be used. The difference between the curing temperature of the material at the outer edge and the curing temperature of the material at the center, which depends on the size (thermal capacity) of the battery, curing conditions, and the like, may be greater than or equal to 5° C. and less than or equal to 30° C. This makes the cured state of the entire insulator 420 uniform.

The thermal conductivity or the hardness of the insulator 420 may be adjusted by containing insulating and highly thermally conductive oxide particles such as alumina. This can reduce the difference in the cured state within the large-sized battery.

The particle size of the oxide particles may be, for example, greater than or equal to 0.5 μm and less than or equal to 1 μm. The content of the oxide particles may be, for example, greater than or equal to 5% by volume and less than or equal to 30% by volume. The particle size and the content can be selected in consideration of the viscosity and the wettability of the resin paste forming the insulator 420, defects such as breaking of a cured film, and bondability.

The insulator 420 may be an applied film.

For example, the insulator 420 may be produced by applying an insulating paste containing the insulating resin material. A resin for use in the insulating paste is only required to function as a binder for binding, and in addition, appropriate ones may be selected depending on the production process to be employed, such as printability and applicability.

The insulator 420 may be a laminated film, not the applied film.

The insulator 420 may have pores. The hardness of the insulator 420 can be even adjusted by the number of the pores. By increasing the number of the pores, the insulator 420 becomes softer.

In the insulator 420, the method for and the effect of containing the pores in the paste are the same as those of the conductor 410.

The collector, the conductor 410, and the insulator 420 may be in descending order of hardness. The degree of difference between hardness of the collector and hardness of the conductor 410 and the degree of difference between hardness of the conductor 410 and hardness of the insulator 420 can be adjusted.

In the bonding layer 400, the conductor 410 and the insulator 420 may have the same thickness. This allows both the conductor 410 and the insulator 420 to be easily in contact with the second collector 150 of the first unit cell 100 and the first collector 210 of the second unit cell 200. Thus, low resistant electric connection and firm interlayer bonding can be obtained. Thus, a battery with low resistance loss and having high reliability can be achieved. The bonding faces are parallel, and thus the positional deviation of the unit cells during laminating is reduced, thus increasing the shape accuracy of the laminated battery.

At least one selected from the group consisting of the conductor 410 and the insulator 420 may be positioned at the outer edge of the bonding layer 400 in plan view of the laminated battery 1000. This enables the unit cells to be bonded to each other at the outer edge, and thus the warping and deformation of the unit cells, which are likely to be apparent at the outer edge, can be reduced. Consequently, interlayer peeling (for example, peeling between the collector and the active material layer), which is likely to occur at the outer edge (especially the corners), can be reduced. Thus, a battery having excellent characteristics and reliability can be achieved.

At least one selected from the group consisting of the conductor 410 and the insulator 420 may be provided in a frame shape or a grid shape. This causes the conductor 410 or the insulator 420 to act as a skeleton structure and can thus reduce the warping and deformation of the battery without increasing the mass of the battery. Thus, the warping and deformation of the battery can be reduced while reducing a decrease in the mass energy density of the battery.

The insulator 420 may be disposed closer to the outer edge of the laminated battery 1000 than the conductor 410 is in plan view. This can reduce spreading of the conductor 410 to the side face of the battery during printing and reduce the occurrence of the deterioration of characteristics by a short circuit and lowered resistance. In addition, this can reduce the oozing out of metal ions to the side face of the laminated battery 1000 by the migration of metal ions (for example, Ag ions) that can be contained in the conductor 410 and reduce the deterioration of battery characteristics. The above configuration can prevent a short circuit while reducing the deformation and warping of the battery, and thus the laminated battery 1000 has high reliability. The insulator 420 may be provided so as to surround the conductor 410 in plan view of the battery.

Part of the bonding layer 400 may be exposed to the surface of the laminated battery 1000. At least one selected from the group consisting of the conductor 410 and the insulator 420 may be exposed to the surface of the laminated battery 1000. At least one selected from the group consisting of the conductor 410 and the insulator 420 may be exposed to the surface of the side face of the laminated battery 1000.

The bonding layer 400 may have an exposed portion protruding outside the outer edge of the first unit cell 100 and the second unit cell 200. At least one selected from the group consisting of the conductor 410 and the insulator 420 may have an exposed portion protruding outside the outer edge of the first unit cell 100 and the second unit cell 200.

The above configuration enables the exposed portion to buffer impact and to protect the side face of the battery in the production process and the like. Consequently, the falling of the active material from the side face of the battery and the deformation of the collector can be reduced.

The insulator 420 may be exposed to the surface of the laminated battery 1000. The insulator 420 may have an exposed portion protruding outside the outer edge of the first unit cell 100 and the second unit cell 200. The above configuration enables the exposed portion to absorb impact in the production process and the like. Consequently, the falling of the active material from the side face of the battery and the deformation of the end of the collector can be reduced. Thus, the deterioration of characteristics and a short circuit of the battery can be reduced.

The exposed portion of the insulator 420 is formed by, for example, applying a paste to form the insulator 420 to the side face of the laminated battery 1000 by screen printing or stamp transcription.

The degree of exposure of the insulator 420 may be greater than or equal to 10 μm. That is, the insulator 420 may protrude from the side face of the battery by greater than or equal to 10 μm.

The surface of the insulator 420 may be roughened to have irregularities. That is, the surface of the insulator 420 may have an embossed shape. This causes air to be easily discharged to the outside via the irregularities when the collector is laminated on the insulator 420 and can thus reduce air remaining within the bonding faces. The parallelism of the bonding faces between the unit cells becomes good, and thus a battery with excellent shape accuracy and reliability can be achieved.

The surface of the insulator 420 having an embossed shape may be the face in contact with the first unit cell 100 or the second unit cell 200.

The surface of the insulator 420 in contact with the second unit cell 200 may have an embossed shape. That is, the embossed shape of the insulator 420 may be present in the face in contact with the first collector 210 of the second unit cell 200. This reduces voids (air accumulation) in connecting faces when the insulator 420 and the collector are pressure-bonded to each other.

The surface roughness Rz of the insulator 420 may be about 1 μm. The roughened surface can be formed during pressurizing using a die having an irregular embossed face. Alternatively, the embossed shape may be formed by abrasion with rough sand paper or the like or sand blasting processing.

The first active material layer may be a positive electrode active material layer. The positive electrode active material layer contains a positive electrode active material.

The positive electrode active material is a material in which metal ions such as lithium (Li) ions or magnesium (Mg) ions are inserted into or removed from a crystal structure at a potential higher than that of the negative electrode and that is oxidized or reduced accordingly.

The positive electrode active material is, for example, a compound containing lithium and a transition metal element. The compound is, for example, an oxide containing lithium and a transition metal element, or a phosphoric acid compound containing lithium and a transition metal element.

Examples of the oxide containing lithium and a transition metal element include lithium-nickel complex oxides such as LiNiₓM₁₋ₓO₂ (wherein M is at least one selected from the group consisting of Co, Al, Mn, V, Cr, Mg, Ca, Ti, Zr, Nb, Mo, and W, in which 0<x<is satisfied), layered oxides such as lithium cobaltate (LiCoO₂) and lithium nickelate (LiNiO₂), and lithium manganate having a spinel structure (for example, LiMn₂O₄, Li₂MnO₃, and LiMnO₂).

Examples of the phosphoric acid compound containing lithium and a transition metal element include lithium iron phosphate (LiFePO₄) having an olivine structure.

As the positive electrode active material, sulfur (S) and sulfides such as lithium sulfide (Li₂S) may be used. In this case, lithium niobate (LiNbO₃) or the like may be applied or added to the positive electrode active material.

For the positive electrode active material, only one of these materials may be used, or two or more of these materials may be used in combination.

To increase lithium-ion conductivity or electron conductivity, the positive electrode active material layer may contain materials other than the positive electrode active material in addition to the positive electrode active material. That is, the positive electrode active material layer may be a compound layer. Examples of the materials include solid electrolytes such as inorganic solid electrolytes and sulfide-based solid electrolytes, conductive aids such as acetylene black, and binders for binding such as polyethylene oxide and polyvinylidene fluoride.

The positive electrode active material layer may be in contact with the surface of the positive electrode collector. The positive electrode active material layer may cover the entire principal face of the positive electrode collector.

The positive electrode active material layer may have a thickness of greater than or equal to 5 μm and less than or equal to 300 μm.

The second active material layer may be a negative electrode active material layer. The negative electrode active material layer contains a negative electrode active material.

The negative electrode active material refers to a material in which metal ions such as lithium (Li) ions or magnesium (Mg) ions are inserted into or removed from a crystal structure at a potential lower than that of the positive electrode and that is oxidized or reduced accordingly.

Examples of the negative electrode active material include carbon materials such as natural graphite, artificial graphite, graphite carbon fibers, and resin-heat-treated carbon and alloy-based materials to be made into a compound with the solid electrolyte. Examples of the alloy-based materials include lithium alloys such as LiAl, LiZn, Li₃Bi, Li₃Cd, Li₃Sb, Li₄Si, Li_{4.4}Pb, Li_{4.4}Sn, Li_{0.17}C, and LiC₆, oxides of lithium and a transition metal element such as lithium titanate (Li₄Ti₅O₁₂), and metal oxides such as zinc oxide (ZnO) and silicon oxide (SiOₓ).

For the negative electrode active material, only one of these materials may be used, or two or more of these materials may be used in combination.

To increase lithium-ion conductivity or electron conductivity, the negative electrode active material layer may contain materials other than the negative electrode active material in addition to the negative electrode active material. Examples of the materials include solid electrolytes such as inorganic solid electrolytes and sulfide-based solid electrolytes, conductive aids such as acetylene black, and binders for binding such as polyethylene oxide and polyvinylidene fluoride.

The negative electrode active material layer may be in contact with the surface of the negative electrode collector. The negative electrode active material layer may cover the entire principal face of the negative electrode collector.

The negative electrode active material layer may have a thickness of greater than or equal to 5 μm and less than or equal to 300 μm.

In FIG. 1, all the first active material layer 120, the first active material layer 220, the second active material layer 140, and the second active material layer 240 are the same in shape, position, and size in plan view, but are not limited thereto.

The solid electrolyte layer 130 is disposed between the first active material layer 120 and the second active material layer 140. The solid electrolyte layer 230 is disposed between the first active material layer 220 and the second active material layer 240. That is, the solid electrolyte layer is disposed between the first active material layer and the second active material layer. The solid electrolyte layer may be in direct contact with both the first active material layer and the second active material layer.

The solid electrolyte layer contains a solid electrolyte. The solid electrolyte layer contains the solid electrolyte, for example, as a main component. Here, the main component refers to a component contained most in terms of mass ratio in the solid electrolyte layer. The solid electrolyte layer may consist only of the solid electrolyte.

The material of the solid electrolyte may be a known solid electrolyte for batteries not having electron conductivity but having ion conductivity.

The material of the solid electrolyte has, for example, the property of conducting metal ions such as lithium ions or magnesium ions.

As the solid electrolyte, sulfide-based solid electrolytes, oxide-based solid electrolytes, or halide solid electrolytes can be used.

Examples of the sulfide-based solid electrolytes include Li₂S—P₂S₅-based ones, Li₂S—SiS₂-based ones, Li₂S—B₂S₃-based ones, Li₂S—GeS₂-based ones, Li₂S—SiS₂—LiI-based ones, Li₂S—SiS₂—Li₃PO₄-based ones, Li₂S—Ge₂S₂-based ones, Li₂S—GeS₂—P₂S₅-based ones, and Li₂S—GeS₂—ZnS-based ones.

Examples of the oxide-based solid electrolytes include lithium-containing metal oxides, lithium-containing metal nitrides, lithium phosphate (Li₃PO₄), and lithium-containing transition metal oxides. Examples of the lithium-containing metal oxides include Li₂O—SiO₂ and Li₂O—SiO₂—P₂O₅. Examples of the lithium-containing metal nitrides include LiₓP_{y}O_{1-z}N_{z} (0<z≤1). Examples of the lithium-containing transition metal oxides include lithium-titanium oxides.

Examples of the halide solid electrolytes include compounds containing Li, M, and X. Alternatively, examples of the halide solid electrolytes include compounds formed of Li, M, and X. Here, M is at least one selected from the group consisting of metal elements other than Li and semi-metal elements. X is at least one selected from the group consisting of F, Cl, Br, and I.

The “semi-metal elements” are B, Si, Ge, As, Sb, and Te. The “metal elements” are all the elements included in Group 1 to Group 12 in the periodic table (excluding hydrogen) and all the elements included in Group 13 to Group 16 in the periodic table (excluding B, Si, Ge, As, Sb, Te, C, N, P, O, S, and Se).

To improve the ion conductivity of the halide solid electrolytes, M may contain Y. M may be Y.

The halide solid electrolytes may be, for example, compounds represented by LiₐMe_{b}Y_{c}X₆. Here, expressions: a+mb+3c=6 and c>0 are satisfied. The value of m represents the valence of Me.

To improve the ion conductivity of the halide solid electrolytes, Me may be at least one selected from the group consisting of Mg, Ca, Sr, Ba, Zn, Sc, Al, Ga, Bi, Zr, Hf, Ti, Sn, Ta, and Nb.

To improve the ion conductivity of the halide solid electrolytes, X may contain at least one selected from the group consisting of Cl and Br.

The halide solid electrolytes may contain, for example, at least one selected from the group consisting of Li₃YCl₆ and Li₃YBr₆.

As the solid electrolyte, only one of these materials may be used, or two or more of these materials may be used in combination.

The solid electrolyte layer may contain a binder for binding such as polyethylene oxide or polyvinylidene fluoride in addition to the solid electrolyte.

The solid electrolyte layer may have a thickness of greater than or equal to 5 μm and less than or equal to 150 μm.

The material of the solid electrolyte may be formed of a flocculate of particles or formed of a sintered structure.

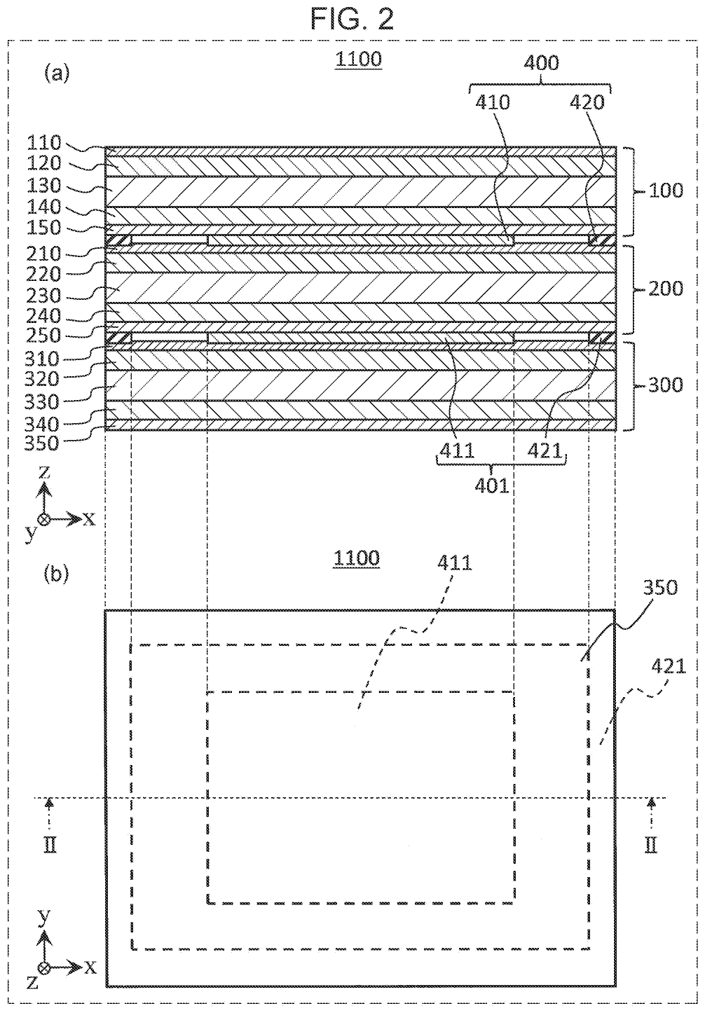

FIG. 2 illustrates a sectional view and a plan view of a schematic configuration of a laminated battery 1100 of a modification of the first embodiment.

FIG. 2(a) is the sectional view of the laminated battery 1100 of the modification of the first embodiment. FIG. 2(b) is the plan view of the laminated battery 1100 of the modification of the first embodiment from below in the z-axis direction. FIG. 2(a) illustrates a section at the position indicated by line II-II in FIG. 2(b).

The laminated battery 1100 includes the first unit cell 100, the bonding layer 400, the second unit cell 200, a bonding layer 401, and a third unit cell 300. The laminated battery 1100 has a configuration in which the third unit cell 300 is further bonded to the laminated battery 1000 with the bonding layer 401. The bonding layer 401 includes a conductor 411 and an insulator 421. The third unit cell 300 and the laminated battery 1000 are electrically connected to each other via the conductor 411.

The third unit cell 300 includes a first collector 310, a first active material layer 320, a solid electrolyte layer 330, a second active material layer 340, and a second collector 350 in this order.

By thus connecting a plurality of unit cells together in series or in parallel to be multilayered, a laminated battery with high voltage and large capacity can be achieved.

The laminated battery of the first embodiment may include four or more unit cells. That is, one or more unit cells may be further connected to the laminated battery 1100.

### Second Embodiment

The following describes a laminated battery of a second embodiment. The matters described in the first embodiment can be omitted as appropriate.

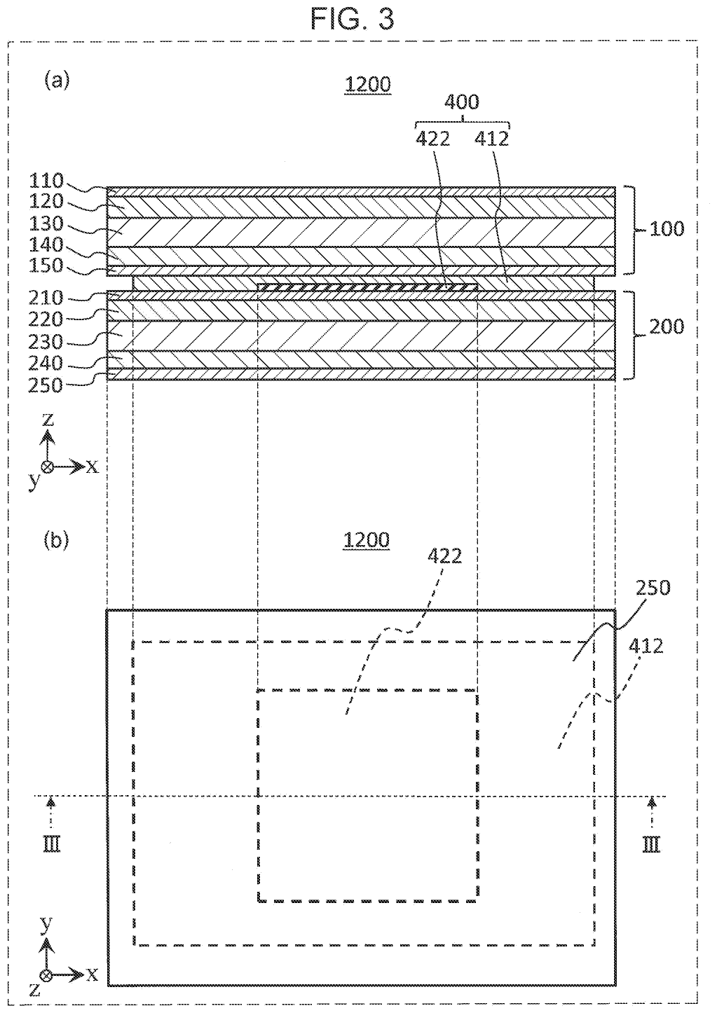

FIG. 3 illustrates a sectional view and a plan view of a schematic configuration of a laminated battery 1200 of the second embodiment.

FIG. 3(a) is the sectional view of the laminated battery 1200 of the second embodiment. FIG. 3(b) is the plan view of the laminated battery 1200 of the second embodiment viewed from below in the z-axis direction. FIG. 3(a) illustrates a section at the position indicated by line III-III in FIG. 3(b).

In the laminated battery 1200 illustrated in FIG. 3(a), an insulator 422 is provided between a conductor 412 and the first collector 210 of the second unit cell 200.

The insulator 422 may be disposed between the first unit cell 100 and the conductor 412. The insulator 422 may be disposed between the conductor 412 and the second collector 150. That is, the insulator 422 may be disposed between the first unit cell 100 or the second unit cell 200 and the conductor 412.

As illustrated in FIG. 3, the conductor 412 and the insulator 422 may be in contact with each other. The conductor 412 and the insulator 422 may be in contact with each other so as to overlap with each other in plan view. For example, as illustrated in FIG. 3, when the conductor 412 covers the insulator 422 so as to overlap therewith, even when a material that easily peels off is used for the insulator 422, the conductor 412 suppresses the peeling off of the insulator 422, thus making the insulator 422 resistant to peeling.

The size, shape, and the like of the conductor 412 and the insulator 422 are not particularly limited so long as the electric connection between the first unit cell and the second unit cell is ensured via the bonding layer 400.

The above configuration can achieve a battery having high reliability with warping and deformation reduced.

The insulator 422 may have a thickness of greater than or equal to 1 μm and less than or equal to 3 μm.

The insulator 422 may be provided at the center of the laminated battery 1200.

The insulator 422 may have a portion embedded by about 1 μm to 2 μm in the collector. The collector has a thickness of, for example, about 20 μm.

The surface of the insulator 422 may be roughened to have irregularities. That is, the surface of the insulator 422 may have an embossed shape. This causes air to be easily discharged to the outside via the irregularities when the collector is laminated on the insulator 422 and can thus reduce air remaining within the bonding faces. In addition, the face having an embossed shape has good wettability, and thus when a conductive paste to form the conductor 412 is applied to or printed on the face having an embossed shape of the insulator 422, its shape and thickness can be controlled with high accuracy. Consequently, the conductor 412 can be prevented from protruding to the side wall and being short-circuited. In addition, the parallelism of the bonding faces between the unit cells becomes good, and thus a battery with excellent shape accuracy and reliability can be achieved.

The surface of the insulator 422 in contact with the second unit cell 200 may have an embossed shape. That is, the embossed shape of the insulator 422 may be present in the face in contact with the first collector 210 of the second unit cell 200. This reduces voids (air accumulation) in connecting faces when the insulator 422 and the collector are pressure-bonded to each other.

The surface of the insulator 422 having an embossed shape may be the face in contact with the conductor 412. This reduces voids (air accumulation) of the bonding faces remaining when the insulator 422 and the conductor 412 is in contact with each other.

The surface roughness Rz of the insulator 422 may be about 1 μm. The roughened surface can be formed during pressurizing using a die having an irregular embossed face. Alternatively, the embossed shape may be formed by abrasion with rough sand paper or the like or sand blasting processing. Owing to the embossed shape, even when a resin material having insufficient wettability is used, it is wetted without repelling the paste or ink of the conductor 412. Thus, the conductor 412 can be applied to or printed on the insulator 422 with high accuracy with objective shape and thickness.

In the laminated battery 1200 illustrated in FIG. 3(a), the conductor 412 is in direct contact with the insulator 422. The conductor 412 may cover the entire one principal face of the insulator 422.

In the conductor 412, the portion overlapping with the insulator 422 may have a thickness of greater than or equal to 1 μm and less than or equal to 5 μm, and the other portion may have a thickness of greater than or equal to 5 μm and less than or equal to 10 μm. This causes the side face of the insulator 422, which is likely to peel off by the difference between the insulator 422 and the collector in deformability or by a temperature cycle, to be covered with the conductor 412. Thus, peeling from the end caused by tensile or compressive stress to the insulator 422 by thermal impact can be reduced. Thus, the reliability of the laminated battery 1200 can be improved.

The conductor 412 is not necessarily disposed at the outer edge of the laminated battery 1200 in plan view in order to prevent the conductor 412 from flowing out to the side face of the laminated battery 1200 and being short-circuited.

In plan view, the conductor 412 may be larger than the insulator 422.

In the laminated battery according to the second embodiment also, three or more unit cells may be laminated on each other as in the laminated battery 1100 according to the modification of the first embodiment.

### Third Embodiment

The following describes a laminated battery of a third embodiment. The matters described in the above embodiments can be omitted as appropriate.

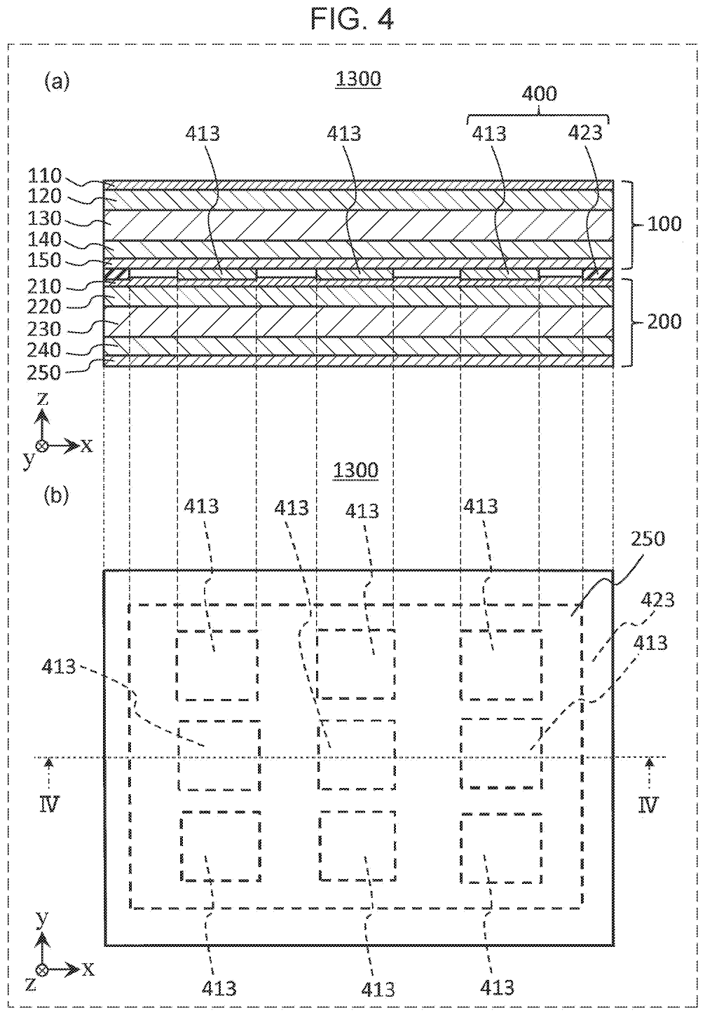

FIG. 4 illustrates a sectional view and a plan view of a schematic configuration of a laminated battery 1300 of the third embodiment.

FIG. 4(a) is the sectional view of the laminated battery 1300 of the third embodiment. FIG. 4(b) is the plan view of the laminated battery 1300 of the third embodiment viewed from below in the z-axis direction. FIG. 4(a) illustrates a section at the position indicated by line IV-IV in FIG. 4(b).

As illustrated in FIG. 4, in the laminated battery 1300, the bonding layer 400 includes a plurality of conductors 413. An insulator 423 is provided in a frame shape along the outer edge of the laminated battery 1300 in plan view.

The laminated battery 1300 includes the conductors 413 and can thus adjust the warping and deformation of a large-sized battery. In addition, the laminated battery 1300 can also adjust partial stress within the battery. Further, plate separation from a screen plate during printing of the conductors 413 becomes good in accordance with a reduction in the area of each of the conductors 413. Consequently, tensile stress to peel the collector, which acts on the collector during printing of the conductors 413, can be reduced. Thus, stress to cause structural defects in the battery, which occur during production of the conductors 413, can be reduced. In addition, when the area of a printing pattern is small, the linearity, position accuracy, and thickness accuracy of the printing pattern improves compared to screen printing with a large-area pattern. Thus, the accuracy of pattern shape and thickness during screen printing of the conductors 413 improves, and thus stable control of warping and deformation can be achieved in the laminated battery 1300. From the above, the laminated battery 1300 can control partial warping and deformation with high accuracy even for a large-sized battery.

The conductors 413 may be disposed in a dispersed manner in accordance with the warping and deformation of the battery. This reduces the warping and deformation of the battery more easily.

The conductors 413 may have a configuration in which the conductors 413 are regularly disposed at certain intervals in plan view of the laminated battery 1300. This can control the effect of reducing warping and deformation for each position on the surface of the unit cell.

Some of the conductors 413 may be insulators in place of the conductors 413.

The laminated battery according to the third embodiment may satisfy at least one selected from (A) and (B) below:
(A) the bonding layer includes a plurality of conductors; and
(B) the bonding layer includes a plurality of insulators.

When (A) is satisfied, the conductors may have a configuration in which the conductors are regularly disposed at certain intervals in plan view of the laminated battery. When (B) is satisfied, the insulators may have a configuration in which the insulators are regularly disposed at certain intervals in plan view of the laminated battery. The conductors and the insulators may have a configuration in which the conductors and the insulators are regularly disposed at certain intervals in plan view of the laminated battery. In this case also, the effect described above can be expected.

When (A) is satisfied, the conductors may have a configuration in which the conductors are periodically disposed in plan view of the laminated battery. When (B) is satisfied, the insulators may have a configuration in which the insulators are periodically disposed in plan view of the laminated battery. The conductors and the insulators may have a configuration in which the conductors and the insulators are periodically disposed in plan view of the laminated battery.

The conductors 413 and the insulators are disposed in a dispersed manner in accordance with the warping and deformation of the battery, thereby reducing warping and deformation more easily.

In the laminated battery according to the third embodiment also, three or more unit cells may be laminated on each other as in the laminated battery according to the modification of the first embodiment.

### Fourth Embodiment

The following describes a laminated battery of a fourth embodiment. The matters described in the above embodiments can be omitted as appropriate.

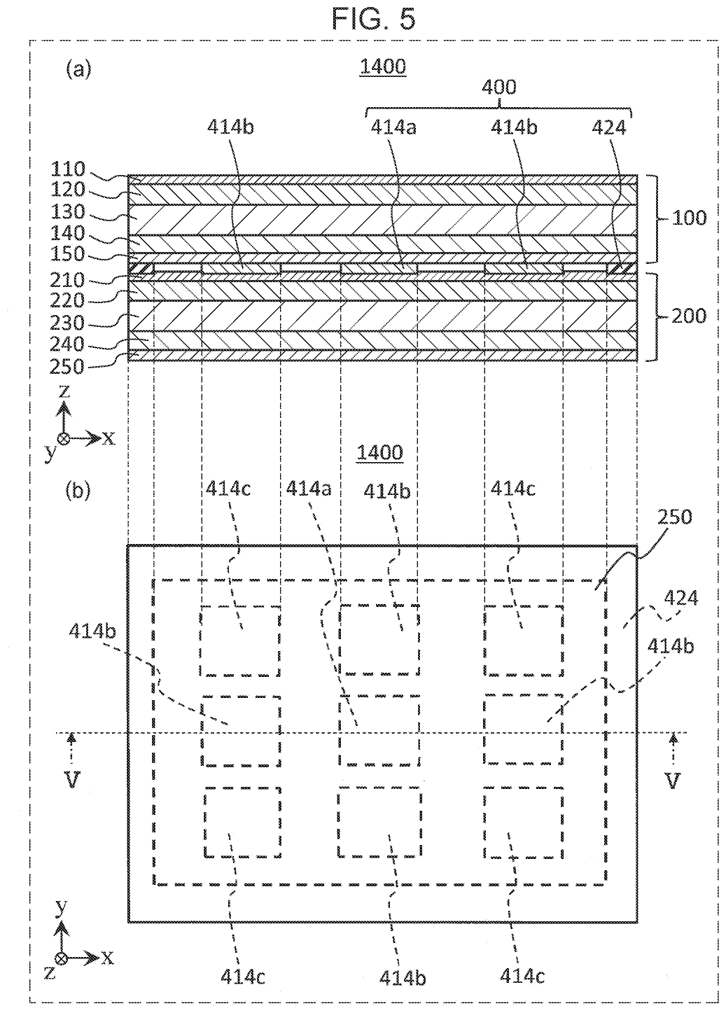

FIG. 5 illustrates a sectional view and a plan view of a schematic configuration of a laminated battery 1400 of the fourth embodiment.

FIG. 5(a) is the sectional view of the laminated battery 1400 of the fourth embodiment. FIG. 5(b) is the plan view of the laminated battery 1400 of the fourth embodiment viewed from below in the z-axis direction. FIG. 5(a) illustrates a section at the position indicated by line V-V in FIG. 5(b).

As illustrated in FIG. 5, in the laminated battery 1400, the bonding layer 400 includes a conductor 414a, conductors 414b, and conductors 414c. The conductor 414a, the conductors 414b, and the conductors 414c differ from each other in hardness. In the following, the conductor 414a, the conductors 414b, and the conductors 414c may be collectively referred to simply as a “conductor 414”. That is, the laminated battery 1400 is different from the laminated battery 1300 in that a plurality of conductors 414 include conductors containing materials that differ from each other in hardness.

Some of the conductors 414 may be insulators in place of the conductors 414. In the laminated battery according to the fourth embodiment, when the bonding layer 400 includes the conductors 414, the conductors 414 may include a first conductor and a second conductor that differ from each other in hardness, and when the bonding layer 400 includes a plurality of insulators, the insulators may include a first insulator and a second insulator that differ from each other in hardness.

The above configuration can respond to stress that differs for each position on the surface of the unit cell. That is, by disposing different materials, appropriate control can be achieved in accordance with position and degree. Thus, partial warping and deformation can be reduced with higher accuracy even for a large-sized and/or thin battery.

The first conductor may be harder than the second conductor and the first conductor may be disposed closer to the outer edge of the battery than the second conductor is in plan view of the laminated battery. In addition, the first insulator may be harder than the second insulator and the first insulator may be disposed closer to the outer edge of the battery than the second insulator is in plan view of the laminated battery. The conductor 414a in FIG. 5(b) may correspond to the second conductor, and the conductors 414b may correspond to the first conductor. That is, the conductors 414b may be harder than the conductor 414a. By disposing harder materials at the outer edge, warping and deformation can be effectively reduced at the outer edge, in which warping and deformation are likely to be apparent. Thus, a battery having high reliability can be achieved.

The hardness of the conductors 414 can be adjusted by the content of metal in the conductors 414. For example, in the laminated battery 1400 illustrated in FIG. 5(b), the central conductor 414a contains Ag particles in an amount of about 60% by mass, the conductors 414b close to the outer edge contain Ag particles in an amount of 70% by mass, and the conductors 414c disposed at the four corners contain Ag particles in an amount of 75% by mass. In this case, the conductors 414c, the conductors 414b, and the conductor 414a can be in descending order of hardness.

Hard metals (for example, Ni or Fe) and Ag may be mixed together. The hardness may be controlled by adjusting their mixing ratio.

The hardness may be controlled by the component of a thermosetting resin material.

The hardness may be adjusted by containing pores in the conductors 414.

In general, when performing pressurizing by a uniaxial press, warping is apparent at the outer edge, and thus outside conductors (close to the outer edge) may be made harder than the inside (central) one.

For the difference among the conductors 414 in hardness and the difference among the insulators in hardness, a relative relation in hardness can be obtained by placing a rigid body intender and comparing sizes of marks as in Vickers hardness. For example, the difference can be obtained by pressing an intender on each part of a section of the battery with the same force and comparing states of dents. The relative relation in hardness can also be estimated from their metal compositions.

The contents of the metal or the pores in the conductors 414 can be compared with each other by observing a section using a SEM or the like and from the area ratio among the metal component, the resin component, and the pores.

The conductors 414 and the insulators may contain respective materials that differ in hardness. This can respond to stress that differs for each position on the surface of the unit cell. That is, by disposing different materials, appropriate control can be achieved in accordance with position and degree. In particular, the warping and deformation of a large-sized and thin battery can be easily reduced.

In the laminated battery according to the fourth embodiment also, three or more unit cells may be laminated on each other as in the laminated battery according to the modification of the first embodiment.

### Fifth Embodiment

The following describes a laminated battery of a fifth embodiment. The matters described in the above embodiments can be omitted as appropriate.

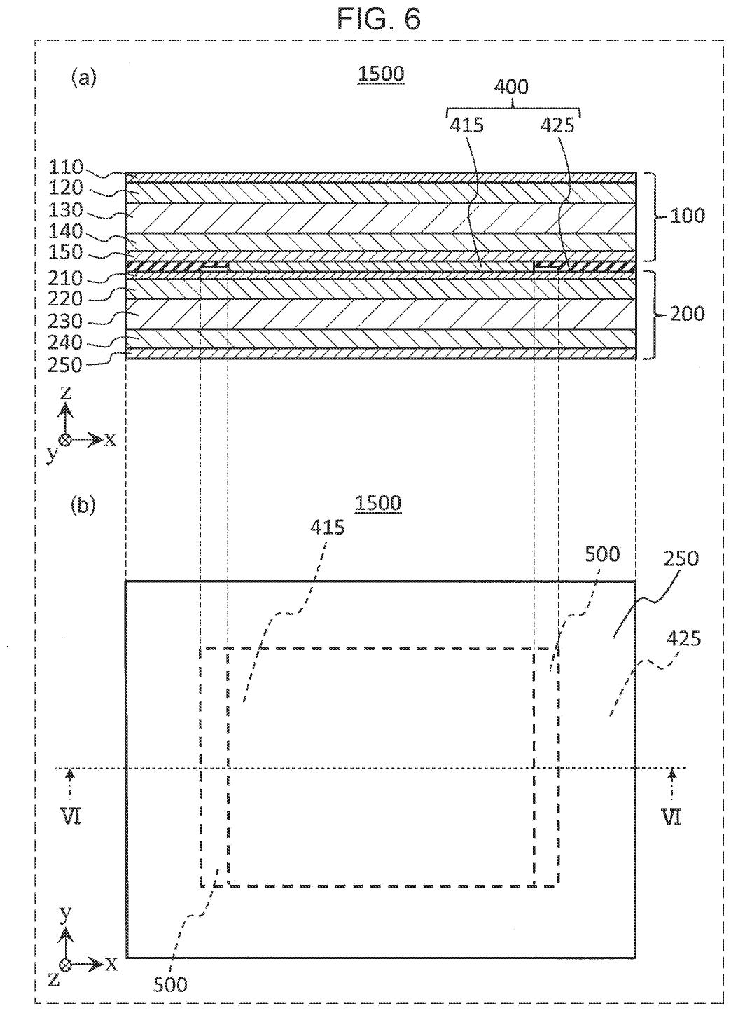

FIG. 6 illustrates a sectional view and a plan view of a schematic configuration of a laminated battery 1500 of the fifth embodiment.

FIG. 6(a) is the sectional view of the laminated battery 1500 of the fifth embodiment. FIG. 6(b) is the plan view of the laminated battery 1500 of the fifth embodiment viewed from below in the z-axis direction. FIG. 6(a) illustrates a section at the position indicated by line VI-VI in FIG. 6(b).

As illustrated in FIG. 6(b), the laminated battery 1500 is different from the laminated battery 1000 in that a conductor 415 is in contact with an insulator 425. In FIG. 6(b), part of the principal face of the conductor 415 is in contact with part of the principal face of the insulator 425 so as to overlap therewith. In FIG. 6(b), the portions in which the conductor 415 and the insulator 425 are in contact with each other are indicated as contact portions 500.

With the above configuration, the conductor 415 is bonded to the insulator 425 at the contact portions 500, thus making the bonding layer 400 firm. In addition, the warping of the collector is buffered by the contact portions 500, thus reducing the deformation of the laminated battery.

As illustrated in FIG. 6(b), the contact portions 500 may have a shape having their long side in a short side direction of the laminated battery 1500 in plan view.

The contact portions 500 may have a shape having their long side in a long side direction of the laminated battery 1500 in plan view. This easily reduces deformation because warping is likely to occur in the long side direction of the laminated battery 1500.

In the laminated battery according to the fifth embodiment also, three or more unit cells may be laminated on each other as in the laminated battery according to the modification of the first embodiment.

### Sixth Embodiment

The following describes a laminated battery of a sixth embodiment. The matters described in the above embodiments can be omitted as appropriate.

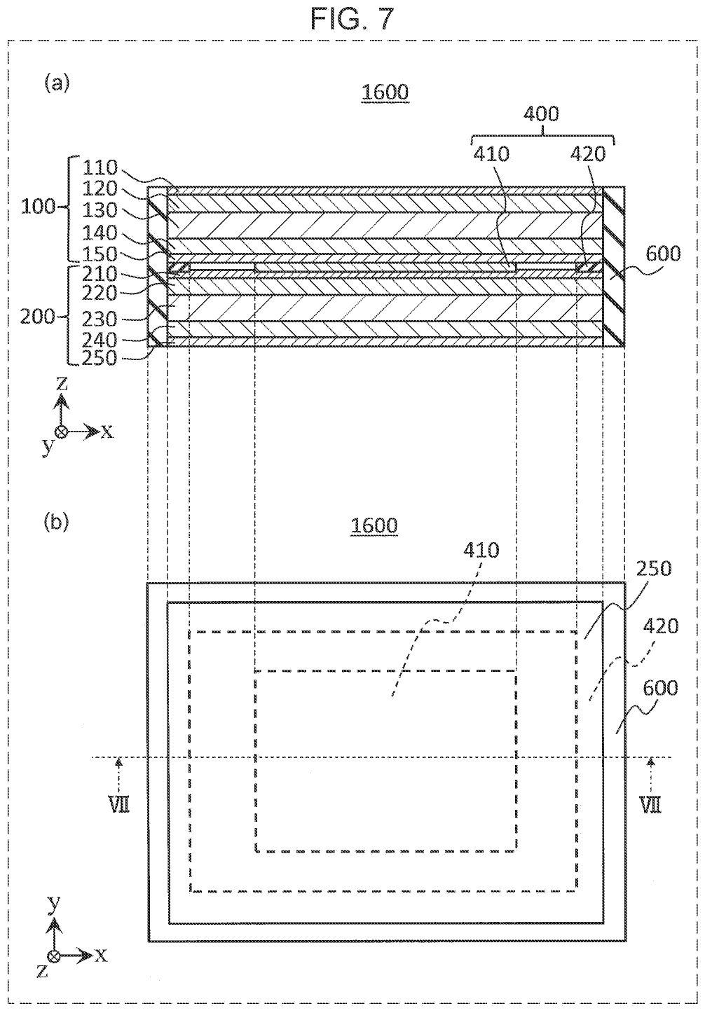

FIG. 7 illustrates a sectional view and a plan view of a schematic configuration of a laminated battery 1600 of the sixth embodiment.

FIG. 7(a) is the sectional view of the laminated battery 1600 of the sixth embodiment. FIG. 7(b) is the plan view of the laminated battery 1600 of the sixth embodiment viewed from below in the z-axis direction. FIG. 7(a) illustrates a section at the position indicated by line VII-VII in FIG. 7(b).

The laminated battery 1600 illustrated in FIG. 7 has a configuration further including a side face insulating member 600 on the side face of the laminated battery 1000 of the first embodiment. The side face insulating member 600 is in contact with the side face of the laminated battery 1000.

The side face insulating member 600 can prevent a short circuit in the unit cell, a short circuit between the unit cells connected to each other, and the adhesion of foreign matter. This can reduce the deterioration of the performance of the laminated battery 1600. Thus, the reliability of the laminated battery 1600 can be improved.

The material of the side face insulating member 600 may be a thermosetting resin. The resin is, for example, an epoxy resin.

The side face insulating member 600 may be in contact with and fixed to the side face of the laminated battery 1000. The side face insulating member 600 may cover at least part of the side face of the laminated battery 1000 or cover the entire side face of the laminated battery 1000.

The side face insulating member 600 may have a thickness of greater than or equal to 30 μm and less than or equal to 100 μm.

The side face insulating member 600 may be in contact with and fixed to part of the bonding layer 400. The side face insulating member 600 may be in contact with at least one selected from the group consisting of the conductor 410 and the insulator 420. This increases the fixing of the side face insulating member 600 by an anchor effect to improve the mechanical strength of the laminated battery 1600. Consequently, a battery resistant to impact and deformation and having excellent performance can be achieved.

As in the laminated battery 1600 illustrated in FIG. 7, the side face insulating member 600 may be in contact with the insulator 420 or in contact with and fixed to the insulator 420.

In the laminated battery according to the sixth embodiment also, three or more unit cells may be laminated on each other as in the laminated battery according to the modification of the first embodiment. That is, the side face insulating member 600 may be provided on the side face of the laminated battery 1100 according to the modification of the first embodiment.

### Seventh Embodiment

The following describes a seventh embodiment. The matters described in the above embodiments can be omitted as appropriate.

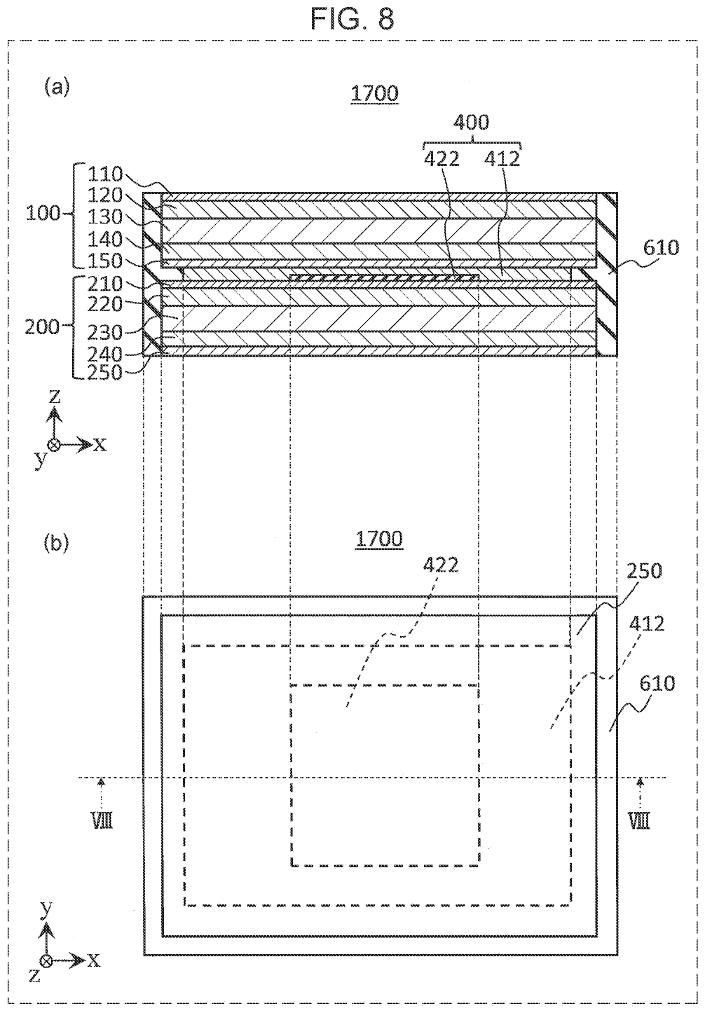

FIG. 8 illustrates a sectional view and a plan view of a schematic configuration of a laminated battery 1700 of the seventh embodiment.

FIG. 8(a) is the sectional view of the laminated battery 1700 of the seventh embodiment. FIG. 8(b) is the plan view of the laminated battery 1700 of the seventh embodiment viewed from below in the z-axis direction. FIG. 8(a) illustrates a section at the position indicated by line VIII-VIII in FIG. 8(b).

The laminated battery 1700 illustrated in FIG. 8 has a configuration further including a side face insulating member 610 on the side face of the laminated battery 1200.

The laminated battery 1700 includes the side face insulating member 610 and can thus reduce deterioration of the performance of the battery as in the laminated battery 1600. Thus, the reliability of the laminated battery 1700 can be improved.

The material of the side face insulating member 610 may be a thermosetting resin. The resin is, for example, an epoxy resin.

The side face insulating member 610 may have a thickness of greater than or equal to 30 μm and less than or equal to 100 μm.

The side face insulating member 610 may be in contact with and fixed to the side face of the laminated battery 1200.

In the laminated battery 1700 illustrated in FIG. 8, the side face insulating member 610 enters the bonding faces of the first unit cell 100 and the second unit cell 200. The side face insulating member 610 may be in contact with and fixed to part of the principal face of the first collector 210, part of the principal face of the second collector 150, and part of the conductor 412. That is, the side face insulating member 610 may be in contact with at least part of the principal face of the first unit cell 100 or the second unit cell 200. This increases the fixing of the side face insulating member 610 by an anchor effect to improve the mechanical strength of the laminated battery 1700. Consequently, a battery resistant to impact and deformation and having excellent performance can be achieved. In addition, the conductor 412, when part of the side face thereof is covered with the side face insulating member 610 to have a structure integrated with the upper and lower collectors, can achieve a battery resistant to impact and stress and having excellent reliability.

### Eighth Embodiment

The following describes an eighth embodiment. The matters described in the above embodiments can be omitted as appropriate.

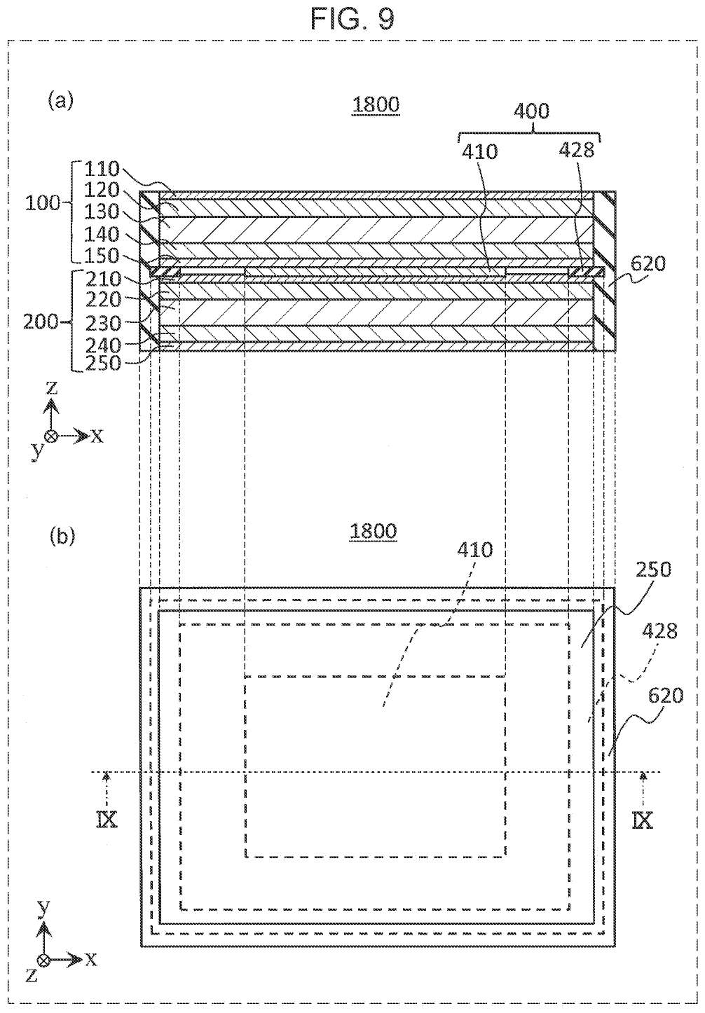

FIG. 9 illustrates a sectional view and a plan view of a schematic configuration of a laminated battery 1800 of the eighth embodiment.

FIG. 9(a) is the sectional view of the laminated battery 1800 of the eighth embodiment. FIG. 9(b) is the plan view of the laminated battery 1800 of the eighth embodiment viewed from below in the z-axis direction. FIG. 9(a) illustrates a section at the position indicated by line IX-IX in FIG. 9(b).

As illustrated in FIG. 9, the laminated battery 1800 includes a side face insulating member 620 on the side face of the laminated battery as in the laminated battery 1600 and the laminated battery 1700. This laminated battery 1800 is different from the laminated battery 1600 in that an insulator 428 has a protruding portion protruding outside the outer edge of the first unit cell 100 and the second unit cell 200. The side face insulating member 620 covers the protruding portion of the insulator 428.

The above configuration enables the protruding portion of the insulator 428 to absorb impact on the side face of the battery in the production process and the like. Consequently, the falling of the active material from the side face of the battery and the deformation of the end of the collector can be reduced. In addition, the fixing of the side face insulating member 620 increases by an anchor effect to improve the mechanical strength of the laminated battery 1800. Consequently, a battery resistant to impact and deformation and having excellent performance can be achieved.

The protruding portion of the insulator 428 can be formed by, for example, applying a paste to form the insulator 428 to the side face of the laminated battery 1000 by screen printing or stamp transcription.

The degree of exposure of the insulator 428 may be greater than or equal to 10 μm. That is, the insulator 428 may protrude from the side face of the laminated battery 1800 by greater than or equal to 10 μm.

As in the insulator 428, the conductor 410 may have a protruding portion protruding outside the outer edge of the first unit cell 100 and the second unit cell 200. The above configuration enables the protruding portion to buffer impact and to protect the side face of the battery in the production process and the like. Consequently, the falling of the active material from the side face of the battery and the deformation of the collector can be reduced. In addition, the fixing of the side face insulating member 620 increases by an anchor effect to improve the mechanical strength of the laminated battery 1800. Thus, a battery resistant to impact and deformation and having excellent performance while reducing the deterioration of characteristics and a short circuit can be achieved.

### Method for Producing Battery

The following describes an example of a method for producing the laminated battery of the present disclosure.

The following describes a method for producing the laminated battery 1000 of the first embodiment as an example.

In the following, the first collector 110 and the first active material layer 120 form a positive electrode, whereas the second active material layer 140 and the second collector 150 form a negative electrode. That is, the first collector 110 is the positive electrode collector, the first active material layer 120 is the positive electrode active material layer, the second active material layer 140 is the negative electrode active material layer, and the second collector 150 is the negative electrode collector.

First, respective pastes for use in printing formation of the positive electrode active material layer and the negative electrode active material layer are produced. As the solid electrolyte for use in the compounds of the positive electrode active material layer and the negative electrode active material layer, for example, glass powder of a Li₂S—P₂S₅-based sulfide with an average particle size of about 2 μm and with a triclinic crystal as a main component is prepared. This glass powder has, for example, an ion conductivity of greater than or equal to 3×10⁻³ S/cm and less than or equal to 4×10⁻³ S/cm.

As the positive electrode active material, for example, powder of Li—Ni—Co—Al complex oxide (for example, LiNi_{0.8}Co_{0.15}Al_{0.05}O₂) with an average particle size of about 3 μm and with a layered structure is used. By dispersing a compound containing the positive electrode active material described above and the glass powder described above in an organic solvent or the like, a paste for the positive electrode active material layer is produced.

As the negative electrode active material, for example, powder of natural graphite with an average particle size of about 4 μm is used. By dispersing a compound containing the negative electrode active material described above and the glass powder described above in an organic solvent or the like, a paste for the negative electrode active material layer is produced.

Next, as the positive electrode collector, Al foil with a thickness of about 20 μm is prepared. As the negative electrode collector, Cu foil with a thickness of about 20 μm is prepared. The paste for the positive electrode active material layer is printed on one surface of the Al foil with a certain shape and with a thickness of about greater than or equal to 50 μm and less than or equal to 100 μm by screen printing. The paste for the negative electrode active material layer is printed on one surface of the Cu foil with a certain shape and with a thickness of about greater than or equal to 50 μm and less than or equal to 100 μm. The paste for the positive electrode active material layer and the paste for the negative electrode active material layer are dried at higher than or equal to 80° C. and lower than or equal to 130° C. Thus, the positive electrode active material layer and the negative electrode active material layer are formed on the positive electrode collector and the negative electrode collector, respectively. The positive electrode and the negative electrode each have a thickness of greater than or equal to 30 μm and less than or equal to 60 μm.

Next, by dispersing a compound containing the glass powder described above in an organic solvent or the like, a paste for the solid electrolyte layer is produced.

The paste for the solid electrolyte layer described above is printed on the positive electrode active material layer and the negative electrode active material layer, for example, with a thickness of about 100 μm using a metal mask. Subsequently, the paste for the solid electrolyte layer is dried at higher than or equal to 80° C. and lower than or equal to 130° C.

Next, the solid electrolyte layer printed on the positive electrode active material layer and the solid electrolyte layer printed on the negative electrode active material layer are laminated on each other so as to face each other being in contact with each other. The laminated body that has been laminated is housed in a die having a rectangular outer shape.

Next, an elastic body sheet (with a thickness of 50 μm to 100 μm) with an elastic modulus of about 5×10⁶ Pa is inserted into between a pressure die plate and the laminated body.

The face of the elastic body sheet to be in contact with the plate-like member may be embossed so as to have a surface roughness Rz of about greater than or equal to 1 μm and less than or equal to 10 μm. The surface roughness Rz of the elastic body sheet may be, for example, greater than or equal to 1 μm and less than or equal to 5 μm.

Subsequently, the pressure die is pressurized with greater than or equal to 300 MPa and less than or equal to 350 MPa for about 90 seconds while heating it at higher than or equal to 50° C. and lower than or equal to 80° C. From the above, the first unit cell is obtained in which the positive electrode collector, the positive electrode active material layer, the solid electrolyte layer, the negative electrode active material layer, and the negative electrode collector are laminated on each other.

Next, onto the principal face of the second collector of the first unit cell, a thermosetting conductive paste containing Ag particles and an epoxy-based insulating resin material, which is thermosetting, are each applied with a thickness of about greater than or equal to 1 μm and less than or equal to 5 μm by screen printing. These will be the conductor and the insulator forming the bonding layer. Subsequently, the second unit cell, which has been produced in the same manner as in the first unit cell, is disposed thereon to make series connection. Subsequently, the first unit cell, the bonding layer, and the second unit cell are compression bonded together with about 10 kg/cm². In this process, the conductor and the insulator may be embedded in the first collector of the second unit cell by about greater than or equal to 1 μm and less than or equal to 3 μm from the principal face of the first collector of the second unit cell. This produces an anchor effect to achieve a firm bonded state.

Subsequently, the laminated body is immobilized while applying pressure (for example, about 1 kg/cm²) thereto and is subjected to thermosetting processing at about 100° C. to 130° C. for 40 minutes to 100 minutes. Next, it is gradually cooled to room temperature. Thus, the laminated battery 1000 of the first embodiment is obtained.

When the number of unit cells to be connected in series is further increased, that is, when three or more unit cells are laminated on each other, the procedure before the thermosetting processing may be repeated, and then the thermosetting processing may be performed.

When the bonding layer is desired to be formed thin, for example, when the conductor is desired to be formed thin, finer or scale-like particles may be used as the conductive particles such as the Ag particles.

For the purpose of forming an alloy with the collector during curing, a metal with a low melting point can be contained in the conductive paste.

The method and order for forming the battery are not limited to the above example.

The method of production described above shows an example in which the paste for the positive electrode active material layer, the paste for the negative electrode active material layer, the paste for the solid electrolyte layer, the conductive paste, and the insulating resin material are applied by printing; however, the method of application is not limited thereto. As the method of application, for example, the doctor blade method, the calender method, the spin coating method, the dip coating method, the ink jet method, the offset method, the die coating method, or the spray method may be used.

The laminated battery of the present disclosure has been described based on the embodiments. The present disclosure is not limited to these embodiments. For example, a battery obtained by combining the laminated battery of the second embodiment and the laminated battery of the third embodiment with each other may be configured. The scope of the present disclosure also includes ones obtained by making various modifications that those skilled in the art think of to the embodiments and other forms constructed by combining partial components of the embodiments with each other so long as not departing from the gist of the present disclosure.

The laminated battery according to the present disclosure can be used as, for example, secondary batteries such as all-solid lithium-ion batteries for use in various kinds of electronic devices, automobiles, and the like.

What is claimed is:

1. A laminated battery comprising:
a first unit cell;
a second unit cell; and
a bonding layer disposed between the first unit cell and the second unit cell, wherein
the bonding layer includes a conductor and an insulator, and
the first unit cell and the second unit cell are electrically connected to each other via the conductor.

2. The laminated battery according to claim 1, wherein in the bonding layer, the conductor and the insulator have the same thickness.

3. The laminated battery according to claim 1, wherein the conductor contains a conductive resin material.

4. The laminated battery according to claim 3, wherein the conductive resin material contains silver.

5. The laminated battery according to claim 1, wherein the insulator is disposed between the first unit cell or the second unit cell and the conductor.

6. The laminated battery according to claim 1, wherein the insulator contains at least one selected from the group consisting of an insulating resin material and an oxide.

7. The laminated battery according to claim 1, wherein the insulator is softer than the conductor.

8. The laminated battery according to claim 1, wherein at least one selected from the group consisting of the conductor and the insulator is positioned at an outer edge of the bonding layer in plan view of the laminated battery.

9. The laminated battery according to claim 1, wherein part of the bonding layer is exposed to a surface of the laminated battery.

10. The laminated battery according to claim 1, wherein at least one selected from the group consisting of the conductor and the insulator is provided in a frame shape or a grid shape.

11. The laminated battery according to claim 1, satisfying at least one selected from (A) and (B) below:
(A) the bonding layer includes a plurality of conductors; and
(B) the bonding layer includes a plurality of insulators.

12. The laminated battery according to claim 11, wherein
when (A) is satisfied, the conductors include a first conductor and a second conductor that differ from each other in hardness, and
when (B) is satisfied, the insulators include a first insulator and a second insulator that differ from each other in hardness.

13. The laminated battery according to claim 12, wherein
the first conductor is harder than the second conductor, and the first conductor is positioned closer to an outer edge of the battery than the second conductor is in plan view of the laminated battery, and
the first insulator is harder than the second insulator, and the first insulator is positioned closer to the outer edge of the battery than the second insulator is in plan view of the laminated battery.

14. The laminated battery according to claim 11, wherein
when (A) is satisfied, the conductors have a configuration in which the conductors are regularly disposed at certain intervals in plan view of the laminated battery, and
when (B) is satisfied, the insulators have a configuration in which the insulators are regularly disposed at certain intervals in plan view of the laminated battery.

15. The laminated battery according to claim 1, wherein at least one selected from the group consisting of the conductor and the insulator has a portion embedded in at least one selected from the group consisting of the first unit cell and the second unit cell.

16. The laminated battery according to claim 1, wherein the conductor is in contact with the insulator.

17. The laminated battery according to claim 1, wherein a surface of the insulator has an embossed shape.

18. The laminated battery according to claim 17, wherein the surface is a face in contact with the first unit cell or the second unit cell.

19. The laminated battery according to claim 17, wherein the surface is a face in contact with the conductor.

20. The laminated battery according to claim 1, further comprising a side face insulating member, wherein the side face insulating member is in contact with a side face of the laminated battery.

21. The laminated battery according to claim 20, wherein the side face insulating member is in contact with at least one selected from the group consisting of the conductor and the insulator.
